(19) United States
(12) Patent Application Publication
(10) Pub. No.: US 2019/0171150 A1
(43) Pub. Date: Jun. 6, 2019

(54) IMAGE FORMING APPARATUS

(71) Applicant: Konica Minolta, Inc., Tokyo (JP)

(72) Inventor: Hiroyuki ARAI, Tokyo (JP)

(73) Assignee: Konica Minolta, Inc., Tokyo (JP)

(21) Appl. No.: 15/899,440

(22) Filed: Feb. 20, 2018

(30) Foreign Application Priority Data
Mar. 7, 2017 (JP) 2017-042302

(51) Int. Cl. G03G 15/00

(52) U.S. Cl. CPC G03G 15/55

(57) ABSTRACT

An image forming apparatus includes: a display part that displays information related to image formation; a detection part that detects an abnormal paper feeding when a paper sheet is fed from a paper feed tray storing a paper sheet; and a hardware processor that causes the display part to display a paper feed adjustment screen to which a user can input an adjustment of a paper feed condition at a time of paper feeding, when the detection part detects an abnormal paper feeding.

The entire disclosure of Japanese patent Application No. 2017-042302, filed on Mar. 7, 2017, is incorporated herein by reference in its entirety.

### BACKGROUND

### Technological Field

The present invention relates to an image forming apparatus.

### Description of the Related Art

An image forming apparatus generally includes a plurality of paper feed trays, and forms an image by feeding a paper sheet from one of the paper feed trays. It is designed such that recording materials such as cut papers stacked on a paper feed tray are fed one by one onto a conveying path by a paper feed roller or the like. However, depending on a paper type, there may be occurrence of a misfeed jam in which feeding of a paper sheet is inhibited at a time of paper feeding from a paper feed tray, an double feed jam in which multiple paper sheets are conveyed while being stacked, or the like.

Conventionally, when a jam is detected, control has been performed to stop the image forming apparatus after ejecting a paper sheet downstream of the jam occurrence position. At this time, a user has been required to remove the jammed paper. Furthermore, after removing the jammed paper, the user operates an operation part to select and display a desired paper feed adjustment screen as required, performs paper feed adjustment, and restarts the job.

It has been a problem that downtime occurs during this work. In particular, in a field of production printing, since productivity of a printed matter is directly linked to profitability of a project, it is strongly desired not to generate downtime as much as possible.

Therefore, J P 2010-66692 A discloses a technique of changing a paper feed tray to continue printing when a jam occurs.

Specifically, when it is determined that a double feeding has occurred at a time of paper feeding from a paper feed tray, the printing operation is stopped. Then, when there is another paper feed tray storing a paper sheet having a same size and type as a paper sheet stored in the paper feed tray in which the double feeding has occurred, the paper feed source is switched to this another paper feed tray, and the printing operation is executed again. This can suppress a decrease in productivity as compared with a case where image formation is stopped immediately after a double feeding occurs.

In the invention described in JP 2010-66692 A, printing can be continued by switching the paper feed tray, and productivity can be improved. However, in order to execute paper feed adjustment, a user himself has been required to display a paper feed adjustment screen to select an appropriate adjustment item, taking time and effort.

### SUMMARY

The present invention has been made in view of the above problems, and it is an object of the present invention to provide an image forming apparatus capable of easy paper feed adjustment without requiring a user to perform a complicated operation for a paper jam at a time of paper feeding.

To achieve the abovementioned object, according to an aspect of the present invention, an image forming apparatus reflecting one aspect of the present invention comprises:

a display part that displays information related to image formation;

a detection part that detects an abnormal paper feeding when a paper sheet is fed from a paper feed tray storing a paper sheet; and

a hardware processor that causes the display part to display a paper feed adjustment screen to which a user can input an adjustment of a paper feed condition at a time of paper feeding, when the detection part detects an abnormal paper feeding.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view showing a schematic configuration of an image forming apparatus according to an embodiment of the present invention;

FIG. 2 is a block diagram showing a functional configuration of the image forming apparatus according to an embodiment of the present invention;

FIG. 3 is a view showing a schematic configuration of a paper feeding part;

FIG. 4 is a flowchart showing an example of a paper feed adjustment operation of the image forming apparatus according to an embodiment of the present invention;

FIG. 5 is a flowchart showing an example of an operation at a time of paper feed adjustment when a paper feed tray is changed;

FIG. 6 is a flowchart showing an example of an operation at a time of paper feed adjustment when the paper feed tray is not changed;

FIG. 7 is a view showing an example of a method of calculating an adjustment value;

FIG. 8 is a view showing an example of an operation panel displaying a selection screen;

FIG. 9 is a view showing an example of the operation panel displaying jam occurrence information and a release instruction;

FIG. 10 is a view showing an example of the operation panel at a time of normal image formation;

FIG. 11 is a view showing an example of the operation panel displaying a paper feed adjustment screen;

FIG. 12 is a view showing an example of the operation panel displaying a selection screen; and

FIG. 13 is a view showing an example of the operation panel displaying the paper feed adjustment screen.

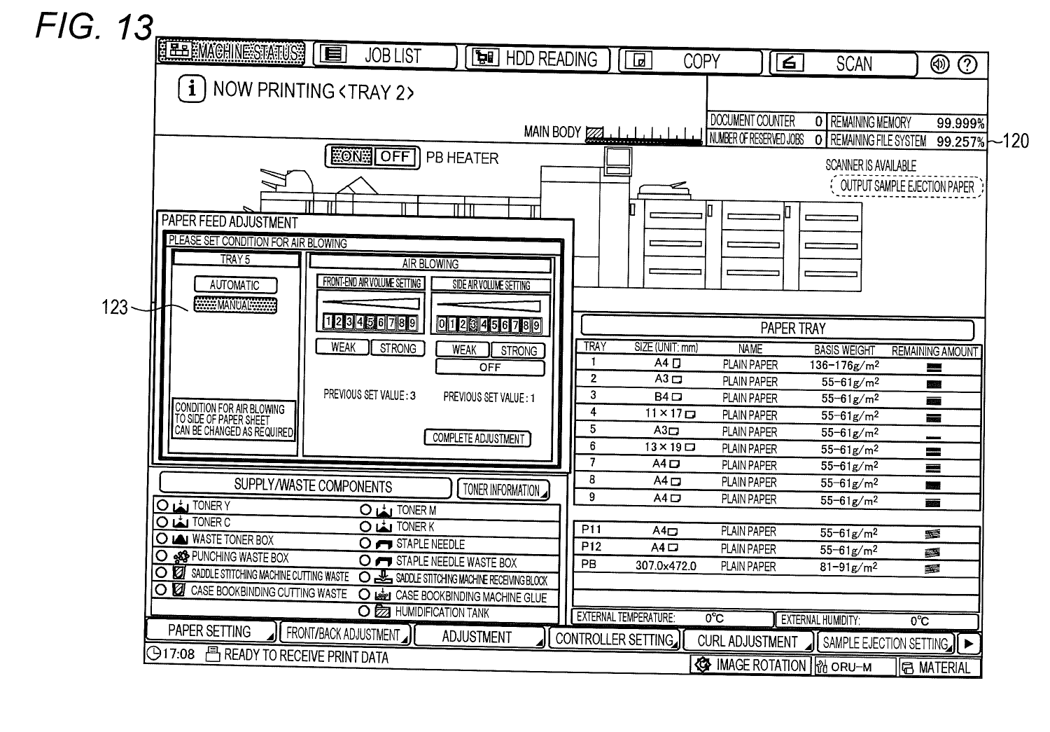

### DETAILED DESCRIPTION OF EMBODIMENTS

Hereinafter, a first embodiment of an image forming apparatus 1 according to the present invention will be described with reference to the drawings. However, the scope of the invention is not limited to the disclosed embodiments.

### [Configuration of Image Forming Apparatus]

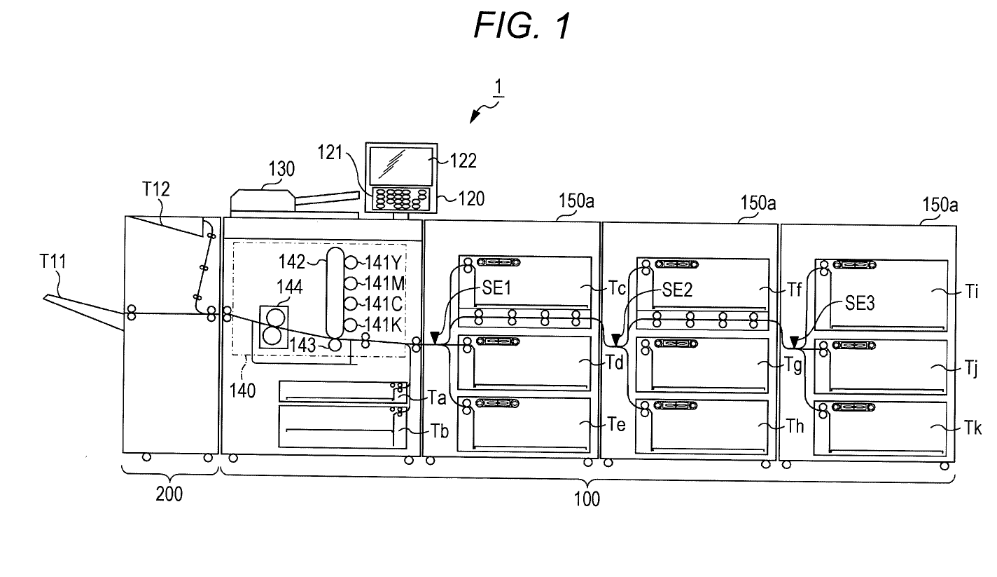

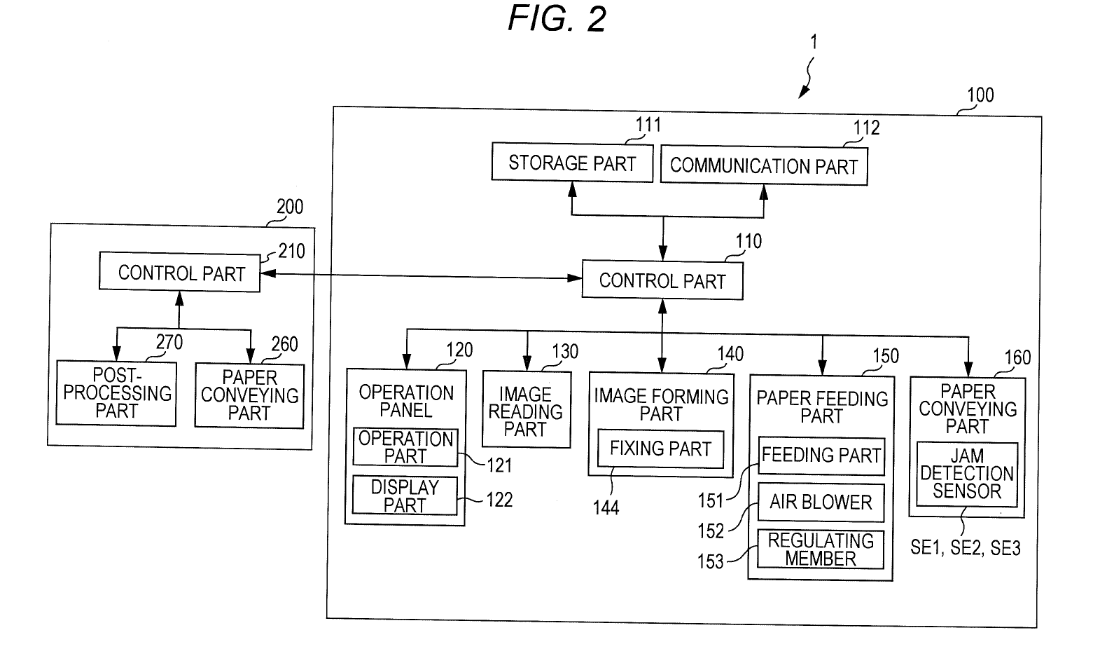

FIG. 1 is a schematic configuration view of the image forming apparatus 1. FIG. 2 is a block diagram showing a functional configuration of the image forming apparatus 1.

The image forming apparatus 1 is made up of a main body 100 and a post-processing apparatus 200.

The main body 100 includes a control part 110, a storage part 111, a communication part 112, an operation panel 120, an image reading part 130, an image forming part 140, a paper feeding part 150, and a paper conveying part 160.

The control part 110 includes a central processing unit (CPU), a read only memory (ROM), a random access memory (RAM), and the like. The CPU reads out various processing programs stored in the ROM in accordance with an operation signal input from an operation part 121, or an instruction signal received by the communication part 112, to develop the processing programs in the RAM and provide a centralized control of operation of each part of the main body 100 in accordance with the developed programs.

Upon receiving a print instruction via the communication part 112, the control part 110 causes the storage part 111 to store image data and paper information such as a type of a paper sheet stored in each paper feed tray, a paper basis weight, and a paper size.

The storage part 111 includes a dynamic random access memory (DRAM), which is a semiconductor memory, a hard disk drive (HDD), or the like, and the storage part 111 stores image data acquired by the image reading part 130, image data input from outside via the communication part 112, paper type information such as a type of a paper sheet stored in each paper feed tray, a paper basis weight, and a paper size, paper profile data to be described later, paper feed tray adjustment data, and the like.

The communication part 112 exchanges data with an external device connected to a communication network such as a local area network (LAN).

The operation panel 120 includes the operation part 121 and a display part 122.

The operation part 121 includes a touch panel formed to cover a display screen of the display part 122, and various operation buttons such as a number button and a start button, and the operation part 121 outputs an operation signal based on a user operation to the control part 110.

The display part 122 is formed by a liquid crystal display (LCD), and displays various screens according to an instruction of a display signal input from the control part 110.

The image reading part 130 includes an automatic document feeding device (ADF), a scanner, and the like, and outputs image data acquired by reading an image of a document, to the control part 110.

The image forming part 140 forms an image on a paper sheet fed from the paper feeding part 150 based on the image data read by the image reading part 130 or the image data received from the external device.

The image forming part 140 includes photoreceptor drums 141Y, 141M, 141C, and 141K corresponding to respective colors of yellow (Y), magenta (M), cyan (C), and black (K), an intermediate transfer belt 142, a secondary transfer roller 143, a fixing part 144, a registration roller 145, and the like.

After the photoreceptor drum 141Y is uniformly charged, the photoreceptor drum 141Y is scanned and exposed by a laser beam based on yellow color image data, and an electrostatic latent image is formed. Then, yellow toner is applied to the electrostatic latent image on the photoreceptor drum 141Y, and development is performed.

Since the photoreceptor drums 141M, 141C, and 141K are similar to the photoreceptor drum 141Y, except that the colors to be handled are different, the description will be omitted.

The toner images of the respective colors formed on the photoreceptor drums 141Y, 141M, 141C, and 141K are sequentially transferred onto the rotating intermediate transfer belt 142 (primary transfer). That is, on the intermediate transfer belt 142, there is formed a color toner image in which four color toner images are superimposed.

The color toner image on the intermediate transfer belt 142 is collectively transferred onto a paper sheet by the secondary transfer roller 143 (secondary transfer).

The fixing part 144 includes a heating roller that heats a paper sheet transferred with the color toner image, and a pressure roller that pressurizes the paper sheet, and the fixing part 144 fixes the color toner image to the paper sheet by heating and pressurization.

The paper feeding part 150 includes paper feed trays Ta and Tb, a plurality of paper feed trays Tc to Tk disposed in three paper feeders 150a connected in series, a feeding part 151 disposed at each of the paper feed trays, an air blower 152, a regulating member 153, and the like, and the paper feeding part 150 feeds a paper sheet from one paper feed tray among the paper feed trays Ta to Tk.

Each of the paper feed trays Ta to Tk stores a paper sheet of a type (a size, a paper type, a basis weight, and the like) predetermined in advance for each paper feed tray. The paper sheet stored in each of the paper feed trays Ta to Tk is fed to the image forming part 140 by driving of the feeding part 151.

Each of the paper feed trays Ta to Tk is provided to be capable of being drawn out, and the paper sheet is refilled with each of the paper feed trays Ta to Tk drawn out.

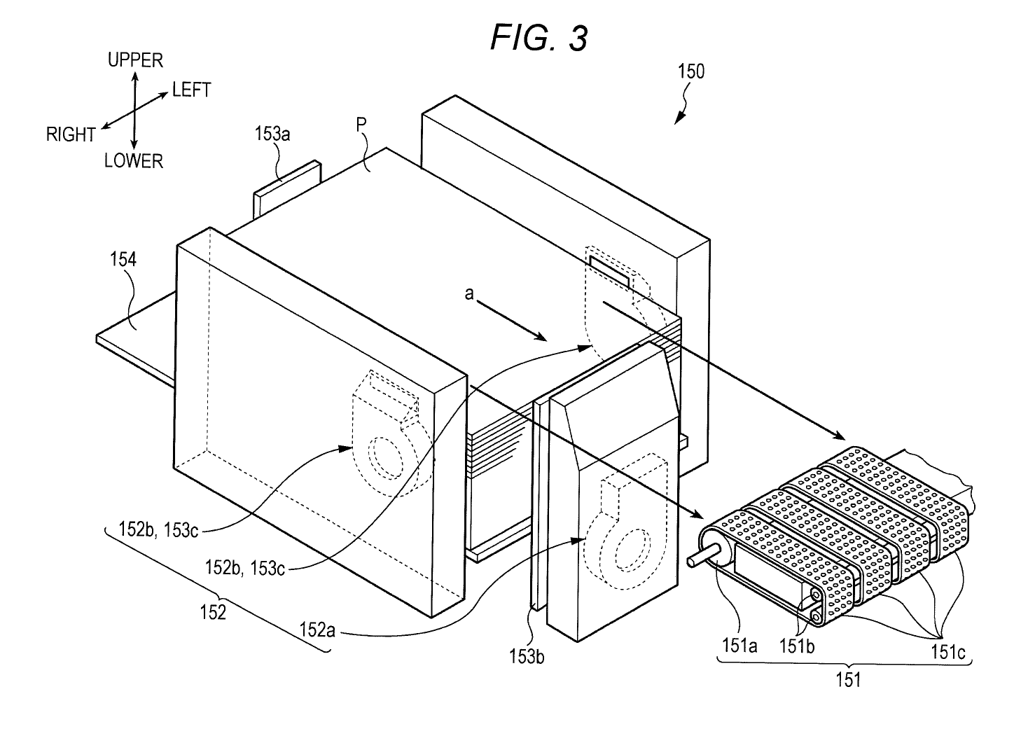

FIG. 3 is a perspective view showing an outline of the paper feed tray Tc. While the paper feed trays Tc to Tk are provided to be vertically aligned in three stages in the paper feeder 150a as described above, since they all are identical in configuration, the one paper feed tray Tc is explained here.

The paper feed tray Tc includes a paper loading base 154 as a horizontally oriented paper loading part placed with a plurality of paper sheets P in a stacked state, a rear-end regulating member 153a provided rearward of the paper loading base 154, namely, upstream of a paper feed direction a, and a front-end regulating member 153b provided forward of the paper loading base 154, namely, downstream of the paper feed direction a. The regulating member 153 is made up of the rear-end regulating member 153a and the front-end regulating member 153b, and a lateral regulating member 153c to be described later.

In the following description of the paper feed tray Tc, a direction of a left hand side in a horizontal direction orthogonal to the paper feed direction a, in a state directed in the paper feed direction a, is defined as “left”, while a direction of a right hand side in the horizontal direction orthogonal to the paper feed direction a, in a state directed in the paper feed direction a, is defined as “right”. Further, in vertical directions orthogonal to the paper feed direction a, an upward direction is defined as “upper” and a downward direction is defined as “lower”.

The paper loading base 154 is vertically movably supported in the paper feed tray Tc, and the rear-end regulating member 153a and the front-end regulating member 153b are fixedly installed in the paper feed tray Tc.

An upper end part of the front-end regulating member 153b is somewhat lower in height than an upper end part of the rear-end regulating member 153a. Meanwhile, the paper loading base 154 is lifted and lowered by an actuator (not shown), and the actuator is controlled by the control part 110 such that an uppermost part of the paper sheet P stacked on the paper loading base 154 is maintained at a specified height slightly lower than the upper end part of the front-end regulating member 153b. The height control with the actuator is performed based on sensing of a sensor (not shown) that is provided on the rear-end regulating member 153a side and detects a height of the uppermost paper sheet P.

Further, at a time of non-feeding, such as a time of supplying the paper sheet P, the paper loading base 154 can be lowered.

Being adjacent to the front-end regulating member 153b, a separation air blower 152a is provided downstream of the front-end regulating member 153b in the paper feed direction a. Further, a floating air blower 152b is provided on each of both a right and left sides of the paper loading base 154, and the air blower 152 is made up of the separation air blower 152a and the floating air blower 152b. An inner side surface of this floating air blower 152b is smooth and along a vertical direction, and functions as the lateral regulating member 153c that regulates a position of the paper sheet in a lateral direction.

A blowing fan is provided each inside of the separation air blower 152a and the floating air blower 152b, and configured to blow air from an air blowing port.

The separation air blower 152a is provided with a nozzle to blow air from the air blowing port toward a direction inclined somewhat upward from a direction of the downstream side in the paper feed direction a. The separation air blower 152a blows air to a front end part in the paper feed direction a of a plurality of the paper sheets P lifted by the floating air blower 152b, to blow air between the lifted paper sheet P and the paper sheet P, enabling separation and lowering of the paper sheet P excluding the uppermost paper sheet P.

As shown in FIG. 3, the floating air blower 152b includes a nozzle to blow air toward the paper sheet P from the left side and the right side of the uppermost paper sheet P positioned at a regulation height, in the horizontal direction or in a direction inclined slightly upward from the horizontal direction. The air blowing port of each nozzle is formed such that its upper edge part is higher than the uppermost paper sheet P positioned at the regulation height, and its lower edge part is lower than the uppermost paper sheet P.

This enables lifting of the upper paper sheet P by blowing air from each air blowing port of the floating air blower 152b to apply air to the upper paper sheet P in the stacked state.

As shown in FIG. 3, the feeding part 151 is provided above the paper loading base 154. FIG. 3 illustrates the feeding part 151 shifted to a position indicated by arrows so as not to hide a surrounding configuration, but the feeding part 151 is actually arranged above a downstream side end part of the paper feed direction a of the paper loading base 154.

The feeding part 151 includes four sets of belt mechanisms aligned in a horizontal direction orthogonal to the paper feed direction a, and a motor (not shown) serving as a paper feeding driving source to drive these belt mechanisms.

Each of the belt mechanisms has a large-diameter roller 151a provided upstream in the paper feed direction a, two small-diameter rollers 151b provided downstream in the paper feed direction a, and a belt 151c stretched over these rollers. Torque is applied from the motor to the large-diameter roller 151a of each belt mechanism in a direction in which a lower part of the each belt 151c advances toward the paper feed direction a. Note that a sprocket may be used instead of each roller.

With the configuration above, when the upper paper sheet P on the paper loading base 154 is lifted by air blown by the floating air blower 152b described above, the feeding part 151 causes the lifted uppermost paper sheet P to attach below the each belt 151c, enabling feeding of the paper sheet P toward the paper feed direction a by rotationally driving the each belt 151c.

The paper conveying part 160 includes a conveying roller or the like to convey the paper sheet on a paper conveyance path, and conveys the paper sheet.

Further, the paper conveying part 160 has JAM detection sensors SE1, SE2, and SE3 on the paper conveyance paths on downstream of the paper feed trays Tc to Te, Tf to Th, and Ti to Tk respectively, in the paper sheet conveying direction. The JAM detection sensors SE1, SE2, and SE3 include a sensor such as an ultrasonic sensor that can detect a double feed jam and a misfeed jam.

The post-processing apparatus 200 includes a control part 210, a paper conveying part 260, and a post-processing part 270.

The control part 210 includes a central processing unit (CPU), a read only memory (ROM), a random access memory (RAM), and the like. The CPU reads out various processing programs stored in the ROM to develop the processing programs in the RAM and provide a centralized control of operation of each part of the post-processing apparatus 200 in accordance with the developed programs.

The paper conveying part 260 includes a conveying roller or the like to convey the paper sheet on the paper conveyance path, conveys the paper sheet in the post-processing apparatus 200, and discharges the paper sheet to a paper discharging tray T11 or T12 provided outside the post-processing apparatus 200.

The post-processing part 270 performs paper sheet processing such as a sorting process, a staple process, a punching process, a folding process, and a bookbinding process as required, on a paper sheet subjected to image formation by the image forming part 140.

### [Method of Performing Paper Feed Adjustment]

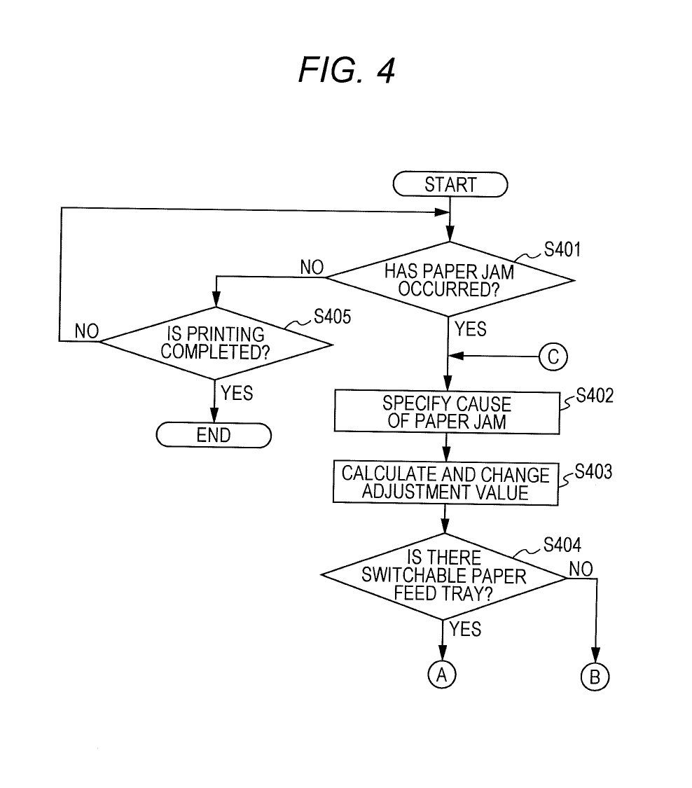

Next, with reference to the flowcharts of FIGS. 4 to 6, a method of performing paper feed adjustment in the image forming apparatus 1 according to the present embodiment will be described.

First, as shown in FIG. 4, the control part 110 determines whether a paper jam has occurred (step S401). When the control part 110 determines that a paper jam has occurred (step S401: Yes), the control part 110 (a specification part) specifies a cause of the paper jam (step S402).

Here, the paper jam includes a misfeed jam in which feeding of a paper sheet is inhibited, a double feeding in which multiple paper sheets are fed while being stacked, and the like. The control part 110 determines which type of a paper jam has occurred, based on a detection result of the JAM detection sensor.

When the cause of the paper jam is specified, the control part 110 (a calculation part, a change part) calculates an adjustment value of a paper feed condition, and changes the paper feed condition to the calculated adjustment value (step S403).

Here, the paper feed condition is to perform at least one of: an air volume, an air direction, and an air blowing timing by the air blower 152; selection of the air blower 152 to be operated (either one or both of the separation air blower 152a and the floating air blower 152b); an operating time of the feeding part 151; a position of the regulating member 153; and presence/absence of re-execution of a paper feeding operation.

Further, the adjustment value of the paper feed condition is calculated based on the cause of the paper jam, and at least one of a paper type, a paper basis weight, a paper size, and a number of paper sheets fed before the paper jam occurs.

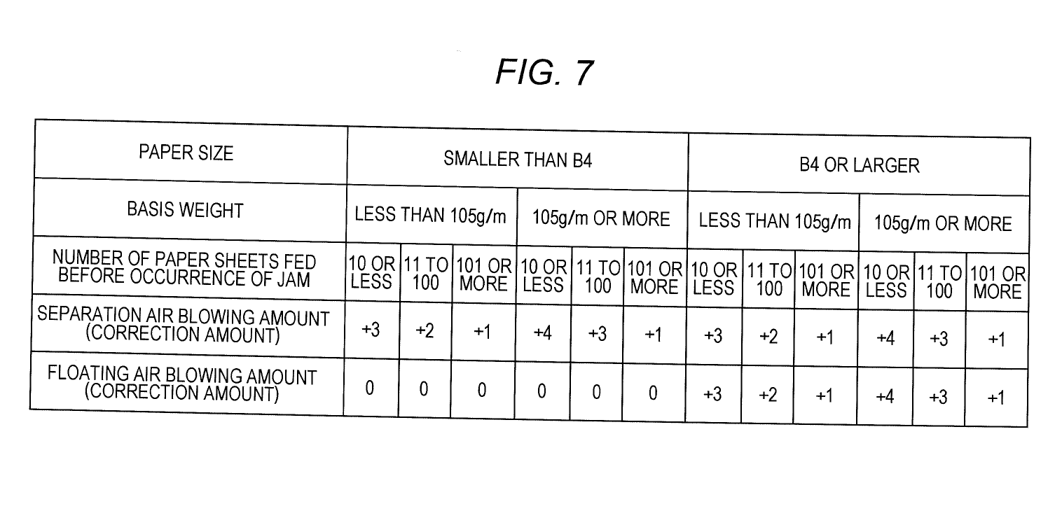

FIG. 7 shows an example of a method of calculating an adjustment value of the paper feed condition. The adjustment value is calculated using a correction amount stored in advance in the storage part 111 in a form of a table.

For example, when the paper size is B4 or larger, the paper basis weight is less than 105 g/m, and the number of the paper sheets fed before the paper jam occurs is 10 or less, an air-blowing volume of the separation air blower 152a is changed to a value added with 3, and an air-blowing volume of the floating air blower 152b is changed to a value added with 3 (an adjustment value).

That is, it is effective to increase the air-blowing volume of the floating air blower 152b when the paper size is large, and to increase the air-blowing volume of the separation air blower 152a and the floating air blower 152b as the paper basis weight is larger, and as the number of paper sheets fed before the paper jam occurs is less.

When the adjustment value is calculated, the control part 110 (a job execution control part) determines whether there is a switchable paper feed tray (step S404). That is, the control part 110 determines whether there is a paper feed tray storing a paper sheet of a same type and same size as that of the paper feed tray where the paper jam has occurred.

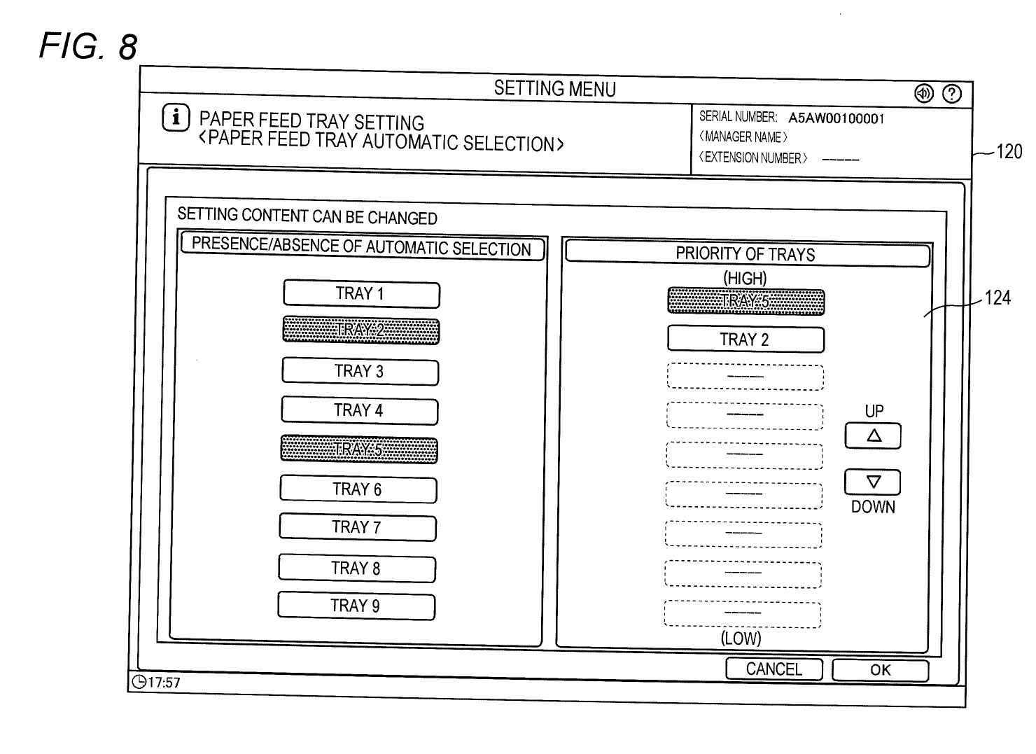

FIG. 8 shows the operation panel 120 displaying a selection screen 124 of the paper feed tray. For example, as shown in FIG. 8, when a misfeed jam occurs during feeding of an A3-sized paper sheet stored in the tray 5, and when a same A3-sized paper sheet is stored in the tray 2 and the tray 2 is set as an automatic selection tray in “Presence/absence of automatic selection”, it is possible to automatically switch the feeding to the tray 2 to continue the image formation.

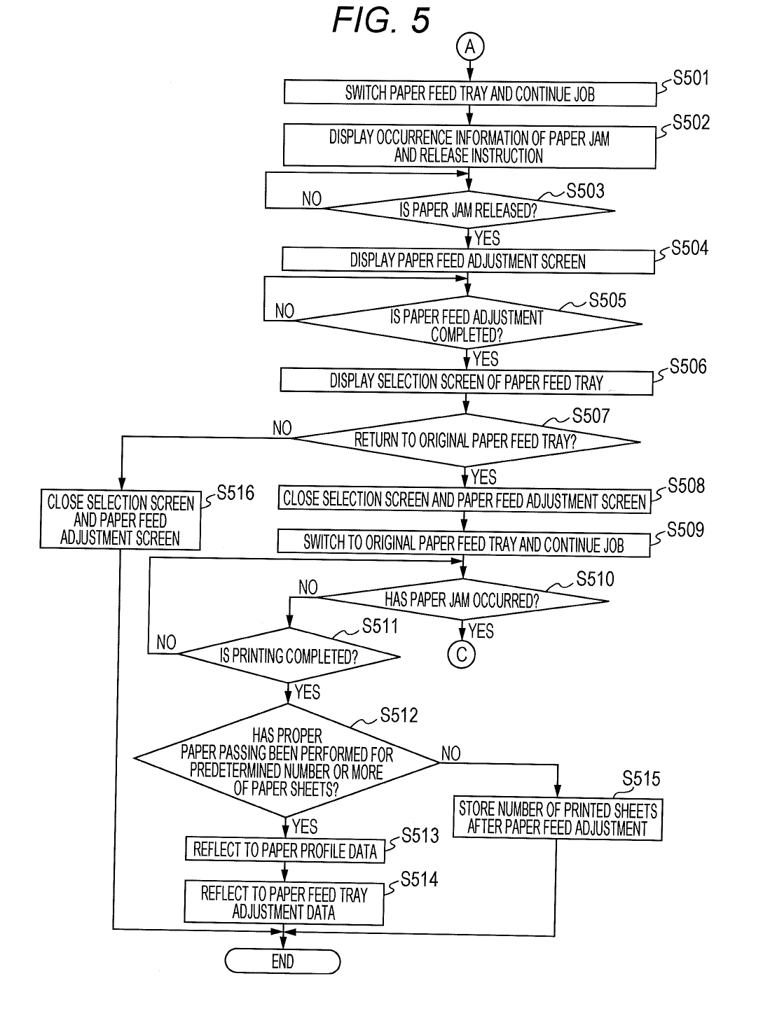

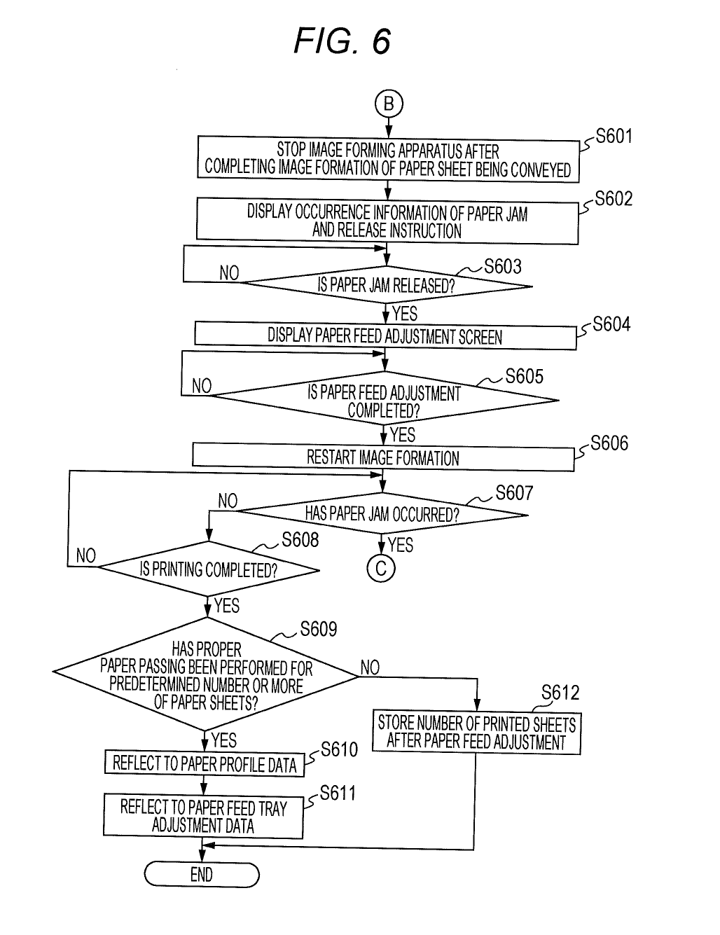

When the control part 110 determines that there is a switchable paper feed tray (step S404: Yes), the process proceeds to step S501 in FIG. 5. When the control part 110 determines that there is no switchable paper feed tray (step S404: No), the process proceeds to step S601 in FIG. 6.

In step S401, when it is determined that a paper jam has not occurred (step S401: No), the control part 110 determines whether printing has been completed (step S405). When determining that the printing has been completed (step S405: Yes), the control part 110 ends the control. When the control part 110 determines that the printing has not been completed (step S405: No), the process returns to step S401.

Next, with reference to FIG. 5, a control when there is a switchable paper feed tray will be described.

In step S501, the control part 110 switches to the switchable paper feed tray to continue the job. Subsequently, the control part 110 causes the operation panel 120 to display occurrence information of the paper jam and a release instruction (step S502).

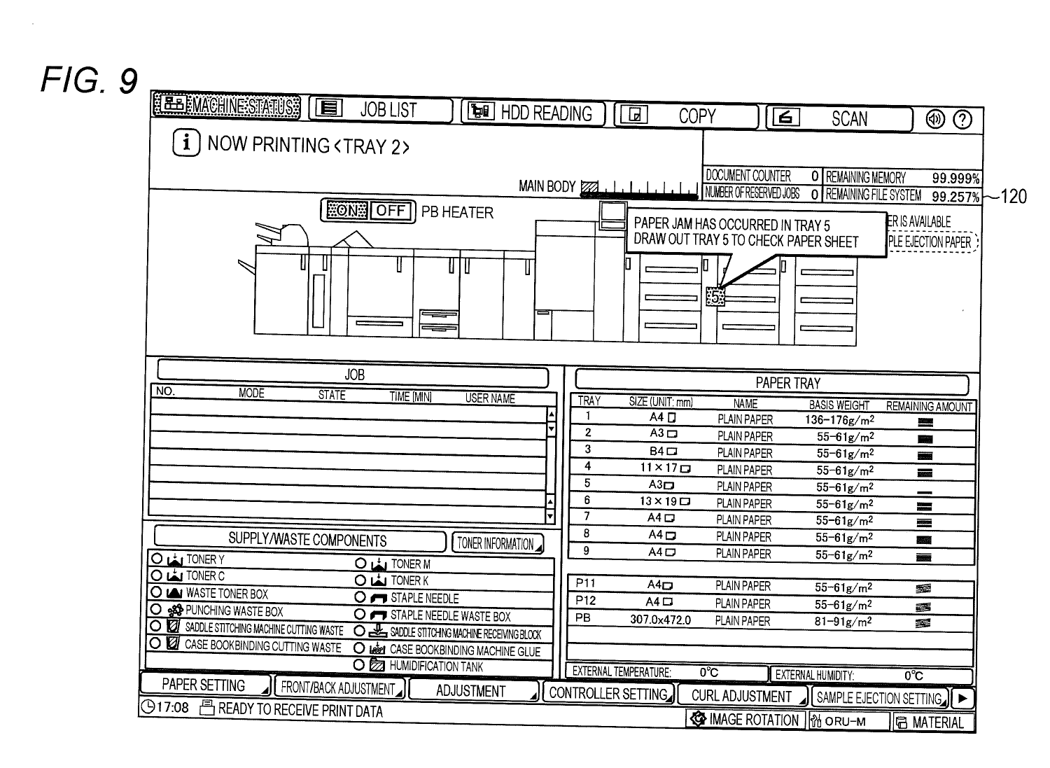

FIG. 9 shows the operation panel 120 displaying the occurrence information of a paper jam and the release instruction. As shown in FIG. 9, the paper feed tray in which the paper jam has occurred is clearly indicated, and a user is prompted to release the paper jam.

The control part 110 determines whether the paper jam has been released by the user who has recognized the display (step S503). When it is determined that the paper jam has not been released (step S503: No), the control part 110 repeats the process of step S503. When it is determined that the jam has been released (step S503: Yes), the process proceeds to step S504.

In step S504, the control part 110 (a display control part) causes a paper feed adjustment screen 123 to be displayed on the operation panel 120.

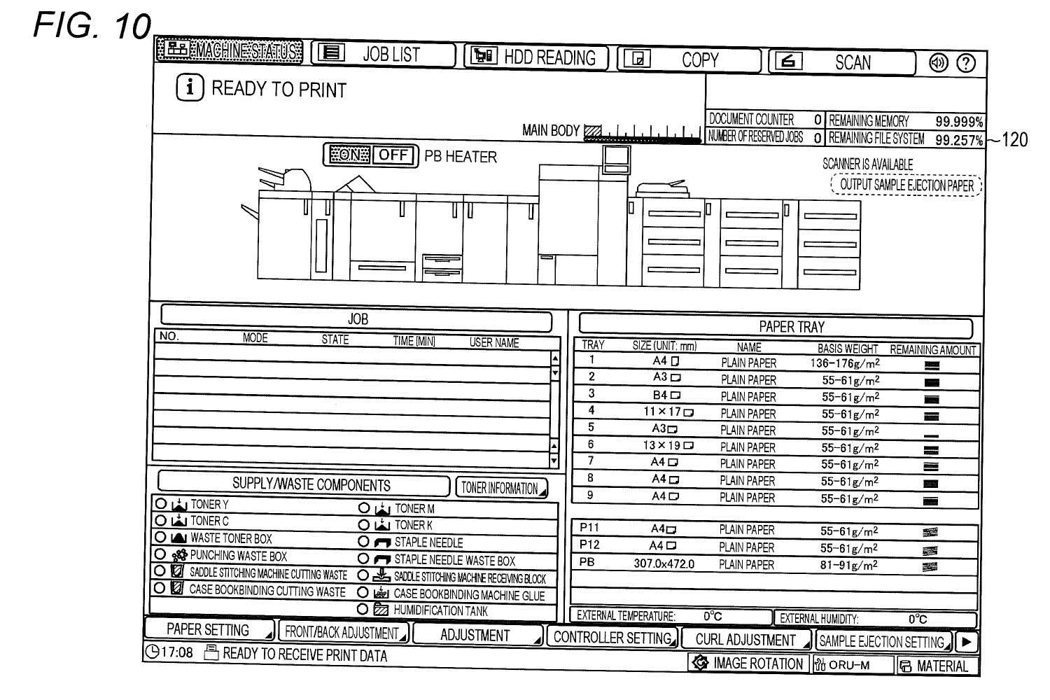

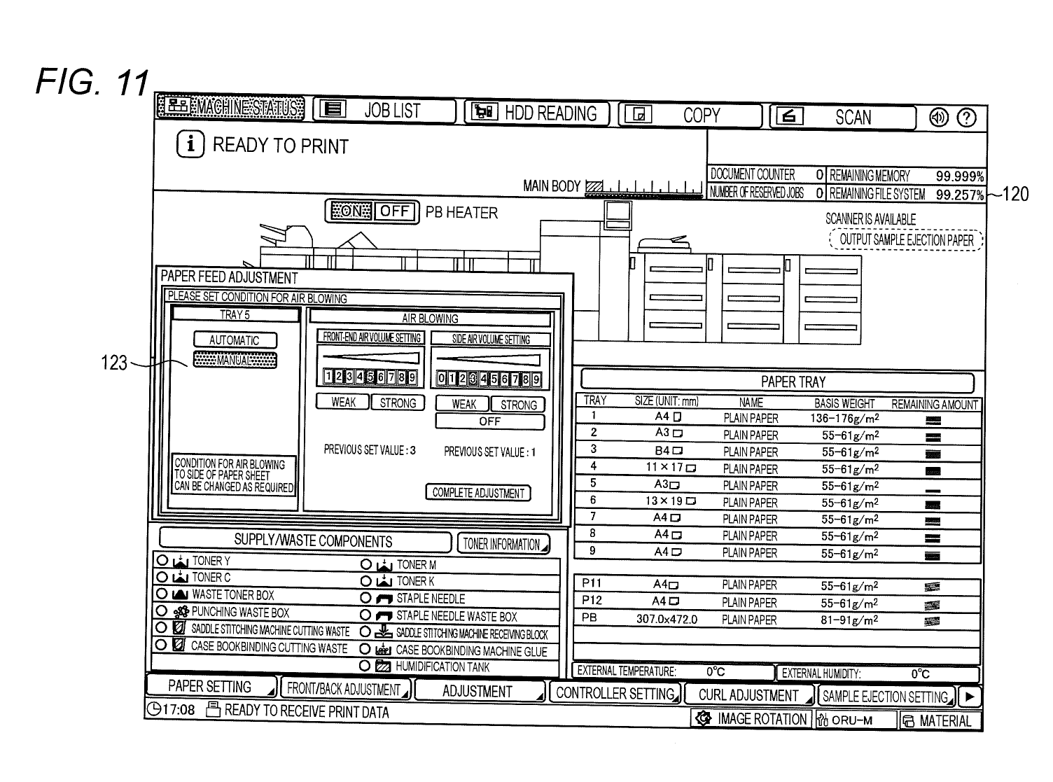

Here, FIG. 10 shows a normal operation panel 120 at a time of image formation, and FIG. 11 shows an operation panel 120 in a state of displaying the paper feed adjustment screen 123. As shown in FIG. 11, the paper feed adjustment screen 123 can be displayed as a pop-up on a part of the operation panel 120. However, the present invention is not limited to this, and the paper feed adjustment screen 123 may be displayed on the entire operation panel 120.

Here, the paper feed adjustment screen 123 is to display at least one of: an air volume, an air direction, and an air blowing timing by the air blower 152; selection of the air blower 152 to be operated (either one or both of the separation air blower 152a and the floating air blower 152b); an operating time of the feeding part 151; a position of the regulating member 153; and presence/absence of re-execution of a paper feeding operation. In FIG. 11, the “Front-end air volume setting” of the separation air blower 152a and the “Side air volume setting” of the floating air blower 152b are displayed, and a user can operate the operation panel 120 to adjust these values. Upon completion of inputting the adjustment value, the user presses “Complete adjustment” at lower right of the paper feed adjustment screen 123, to complete the paper feed adjustment.

Here, on the paper feed adjustment screen 123, the adjustment value of the paper feed condition calculated in step S403 is displayed as a default value.

Further, the operation panel 120 displays the paper feed adjustment screen 123 most related to the paper jam depending on the type of the paper jam. Further, when there are a plurality of related paper feed adjustment screens 123, they are displayed in descending order of relevance.

In step S505, the control part 110 determines whether the paper feed adjustment by the user has been completed. When it is determined that the paper feed adjustment has not been completed (step S505: No), the control part 110 repeats the process of step S505. When it is determined that the paper feed adjustment has been completed (step S505: Yes), the control part 110 (the job execution control part) causes the operation panel 120 to display the selection screen 124 of the paper feed tray (step S506).

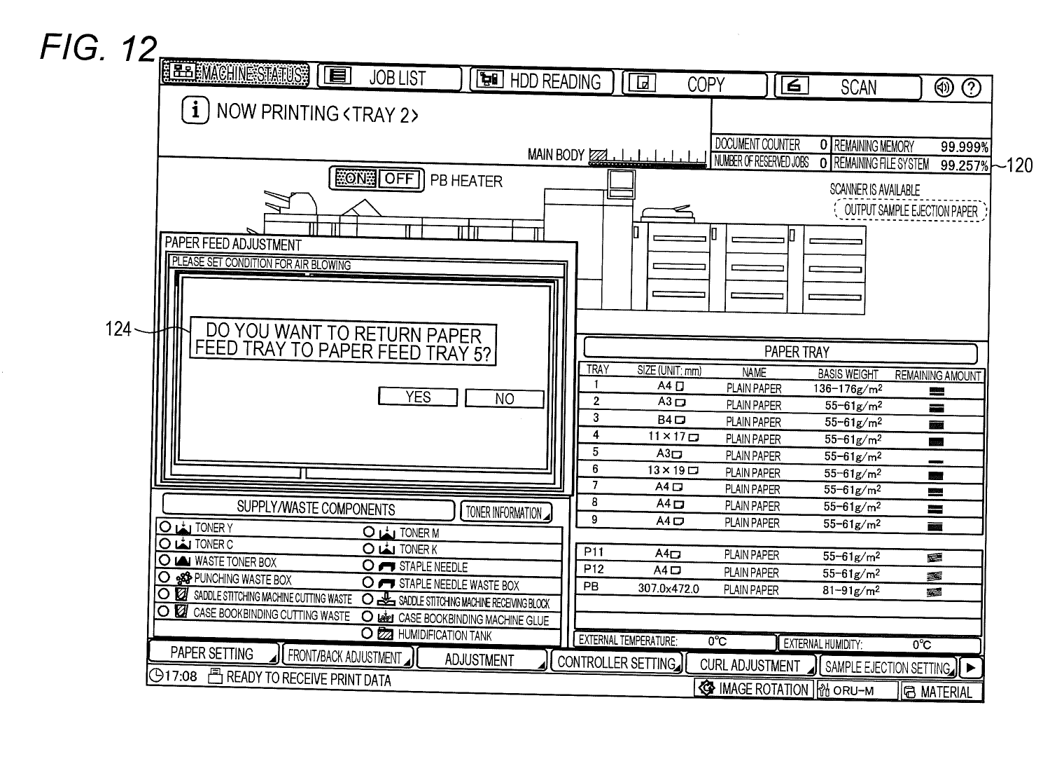

FIG. 12 shows the operation panel 120 in a state of displaying a selection screen 124. When the user presses “Complete adjustment” in step S504, the selection screen 124 is displayed, allowing the user to select whether to return the paper feed tray to the tray 5, which has been originally used for paper feeding.

In step S507, the control part 110 determines whether to return to the original paper feed tray. When it is determined to return to the original paper feed tray (step S507: Yes), the process proceeds to step S508, and when it is determined not to return to the original paper feed tray (step S507: No), the process proceeds to step S516.

In step S508, the control part 110 closes the paper feed adjustment screen 123 and the selection screen 124. In step S509, the control part 110 switches to the original paper feed tray to continue the job.

Next, in step S510, the control part 110 determines whether a paper jam has occurred. When the control part 110 determines that a paper jam has occurred (step S510: Yes), the process proceeds to step S402 in FIG. 4, and the above-described process is repeated.

When the control part 110 determines that no paper jam has occurred (step S510: No), the control part 110 determines whether printing has been completed (step S511). When the control part 110 determines that printing has not been completed (step S511: No), the process returns to step S510. When the control part 110 determines that printing has been completed (step S511: Yes), the control part 110 determines whether proper paper passing has been performed for a predetermined number or more of the paper sheets after the paper feed adjustment (step S512).

When determining that proper paper passing has been performed for the predetermined number or more of the paper sheets (step S512: Yes), the control part 110 causes the storage part 111 to store the paper feed adjustment value as paper profile data corresponding to the fed paper sheet (step S513). Further, the control part 110 causes the storage part 111 to store the paper feed adjustment value as adjustment data of the paper feed tray used for paper feeding (step S514), and ends the control.

Here, the storage part 111 stores the adjustment value of the paper feed condition for each paper sheet type as the paper profile data. When the paper feed adjustment is performed by a user, the storage part 111 updates the adjustment value to a new adjustment value, and stores the adjustment value, in accordance with the control of the control part 110. Therefore, when feeding a same paper sheet next time, the control part 110 can perform paper feed adjustment with reference to the updated paper profile data stored in the storage part 111.

In addition, the storage part 111 similarly stores paper feed tray adjustment data for each paper feed tray, and updates the paper feed tray adjustment data to a new adjustment value, and stores the adjustment value under the control of the control part 110, after the paper feed adjustment by the user.

When the control part 110 determines that proper paper passing has not been performed for the predetermined number or more of paper sheets (step S512: No), that is, when the printing has been completed before reaching the predetermined number of paper sheets, the control part 110 causes the storage part 111 to store the number of printed sheets after the paper feed adjustment (step S515), and ends the control. That is, when a paper sheet of the same paper size is fed or when a paper sheet is fed from the same paper feed tray next time, counting can be continued from the number of printed sheets stored in step S515.

In step S507, when the control part 110 determines not to return to the original paper feed tray (step S507: No), the control part 110 closes the paper feed adjustment screen 123 and the selection screen 124 (step S516), continues feeding of a paper sheet from the paper feed tray currently being used, and ends the control.

Next, with reference to FIG. 6, a control when there is no switchable paper feed tray will be described.

In step S601, the control part 110 stops the image forming apparatus 1 after completing image formation of a paper sheet being conveyed.

Since the processing in steps S602 to S605 is similar to the processing in steps S502 to S505 in FIG. 5, the description will be omitted.

In step S605, when the control part 110 determines that the paper feed adjustment by the user has been completed (step S605: Yes), the control part 110 restarts the image formation (step S606), and the process proceeds to step S607.

Since the processing in steps S607 to S612 is similar to the processing in steps S510 to S515 in FIG. 5, the description will be omitted.

### [Effect]

As described above, the image forming apparatus 1 according to the present embodiment includes: the paper feeding part 150 having a plurality of paper feed trays; the JAM detection sensors SE1, SE2, and SE3 that detect a paper jam; the operation panel 120 that displays the paper feed adjustment screen 123; and the control part 110. When a paper jam occurs, the control part 110 causes the operation panel 120 to display the paper feed adjustment screen 123. Therefore, when a paper jam occurs, the paper feed adjustment screen 123 is automatically displayed. This enables reduction of user's time and effort and enables paper feed adjustment during execution of a job, inhibiting downtime and allowing suppression of a decrease in productivity.

Further, in the present embodiment, when there is a paper feed tray storing a same paper sheet as the paper sheet to which a paper jam occurs, the paper feed tray is switched and the job is continued. Therefore, in such a case, the image forming apparatus 1 is not required to be stopped, inhibiting downtime and allowing suppression of a decrease in productivity.

Further, in the present embodiment, when paper feed adjustment and release of the paper jam are completed, the user can select whether to return to the original paper feed tray. Therefore, paper feeding can be performed with the paper feed tray reset to a suitable adjustment value, enabling reduction of risk of occurrence of a paper jam.

In the present embodiment, a related paper feed adjustment screen 123 is exclusively displayed according to the type of a paper jam. Further, when there are a plurality of related paper feed adjustment screens 123, they are displayed in descending order of relevance. This can improve efficiency of paper feed adjustment.

Further, in the present embodiment, the adjustment value of the paper feed adjustment is calculated and displayed on the paper feed adjustment screen 123, and the value is adjusted based on the adjustment value. Therefore, it is easier to obtain a more suitable adjustment value than when the user optionally sets the value, and it is possible to reduce the time and effort of the user, and the time required for paper feed adjustment.

Further, in the present embodiment, the storage part 111 stores the set adjustment value of the paper feed adjustment as the paper profile data and the paper feed tray adjustment data. Accordingly, this adjustment value is reflected at a time of paper feeding of a same paper sheet or paper feeding from a same paper feed tray next time, enabling paper feeding in a more suitable state and reduction of risk of occurrence of a paper jam.

### OTHER EMBODIMENTS

While specific description has been given above with reference to the embodiment of the present invention, the above-described embodiment is a suitable example of the present invention and is not limited thereto.

For example, in the above embodiment, the paper feed adjustment screen 123 is displayed every time a jam occurs. However, the present invention is not limited to this, and the paper feed adjustment screen 123 may be displayed every predetermined number of times. The predetermined number of times can be optionally set by the user.

Further, when an occurrence frequency of a jam increases after the paper feed adjustment is performed, there may be displayed a value before adjustment, or an adjustment value in a direction opposite to the previous adjustment with the value before adjustment as a reference.

In addition, after occurrence of a paper jam, the user selects whether to switch or not when there is a switchable paper feed tray, but it may be automatically switched under the control of the control part 110.

Further, in a case where a paper jam further occurs in the paper feed tray switched after the occurrence of the paper jam, when there is another switchable paper feed tray, it is also possible to further switch to the another paper feed tray.

Besides, the detailed configuration of each device constituting the image forming apparatus and detailed operation of the each device can be appropriately changed without departing from the gist of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a display part that displays information related to image formation;
a detection part that detects an abnormal paper feeding when a paper sheet is fed from a paper feed tray storing a paper sheet; and
a hardware processor that causes the display part to display a paper feed adjustment screen to which a user can input an adjustment of a paper feed condition at a time of paper feeding, when the detection part detects an abnormal paper feeding.

2. The image forming apparatus according to claim 1, wherein
paper feeding can be performed from a plurality of paper feed trays, and
the image forming apparatus further includes a hardware processor, and in a case where an abnormal paper feeding of a first paper feed tray is detected by the detection part, when there is a second paper feed tray capable of feeding a paper sheet instead of the first paper feed tray among the plurality of paper feed trays, the hardware processor causes the second paper feed tray to feed a paper sheet continues a job.

3. The image forming apparatus according to claim 2, wherein
when an adjustment of a paper feed condition of the first paper feed tray and releasing of an abnormal paper feeding are completed, the hardware processor changes paper feeding from the second paper feed tray to paper feeding from the first paper feed tray.

4. The image forming apparatus according to claim 1, further comprising
a specification part that specifies a cause of the abnormal paper feeding,
wherein the hardware processor causes the display part to exclusively display the paper feed adjustment screen of a paper feed condition according to the cause specified by the specification part.

5. The image forming apparatus according to claim 4, wherein
when there are a plurality of paper feed conditions related to the cause specified by the specification part, the hardware processor causes the display part to display the paper feed adjustment screen in descending order of relevance that is set in advance.

6. The image forming apparatus according to claim 1, further comprising:
a specification part that specifies a cause of the abnormal paper feeding;
a calculation part that calculates an adjustment value of a paper feed condition at a time of paper feeding, based on the cause of the abnormal paper feeding specified by the specification part, and at least one of a paper type, a paper basis weight, a paper size, and a number of paper sheets fed before the abnormal paper feeding; and
a change part that changes a paper feed condition at a time of paper feeding based on an adjustment value calculated by the calculation part.

7. The image forming apparatus according to claim 6, wherein the hardware processor causes the display part to display the paper feed adjustment screen displaying the adjustment value calculated by the calculation part.

8. The image forming apparatus according to claim 1, further comprising:
one or a plurality of air blowers that blow air to a paper sheet stored in the paper feed tray and feed a paper sheet after lifting the paper sheet;
a feeding part that feeds a paper sheet stored in the paper feed tray to outside the paper feed tray; and
a regulating part that regulates a position of an end part of a paper sheet fed from the paper feed tray, wherein
the paper feed condition includes at least one of an air volume, an air direction, and an air blowing timing by the one or a plurality of air blowers, selection of an air blower to be operated among the one or a plurality of air blowers, an operating time of the feeding part, a position of the regulating part, and presence/absence of re-execution of a paper feeding operation.

9. The image forming apparatus according to claim 1, further comprising
a storage part that stores an adjustment result of the paper feed condition executed by a user, as paper profile data for each paper type, wherein
the storage part reflects the adjustment result to the paper profile data of a fed paper sheet, and stores the adjustment result when proper paper passing has been performed for a predetermined number or more of paper sheets.

10. The image forming apparatus according to claim 1, further comprising
a storage part that stores an adjustment result of the paper feed condition executed by a user, as paper feed tray adjustment data for each paper feed tray, wherein
the storage part reflects the adjustment result to the paper feed tray adjustment data of a paper feed tray that has performed paper feeding, and stores the adjustment result when proper paper passing has been performed for a predetermined number or more of paper sheets.

11. The image forming apparatus according to claim 1, wherein, when a number of times of an abnormal paper feeding detected by the detection part reaches a predetermined number of times, the hardware processor causes the display part to display the paper feed adjustment screen.
